(19) United States
(12) Patent Application Publication
(10) Pub. No.: US 2017/0199748 A1
(43) Pub. Date: Jul. 13, 2017

(54) PREVENTING ACCIDENTAL INTERACTION WHEN RENDERING USER INTERFACE COMPONENTS

(71) Applicant: International Business Machines Corporation, Armonk, NY (US)

(72) Inventors: Stanley K. Jerrard-Dunne, Dublin (IE); Alice-Maria Marascu, Dublin (IE); Conor D. McGrath, Dublin (IE)

(21) Appl. No.: 14/994,434

(22) Filed: Jan. 13, 2016

(51) Int. Cl. G06F 9/44; G06F 3/0484; G06F 3/0488

(52) U.S. Cl. CPC G06F 9/4443; G06F 3/04883; G06F 3/04847

(57) ABSTRACT

An approach for preventing accidental interaction when rendering a user interface, the approach involving monitoring a screen record having one or more screen positions and one or more draw times for one or more user interface components of a program application, recording an interaction time associated with a user interface component and retrieving a draw time of the user interface component from the screen record, calculating whether or not an interaction with the user interface component was incorrectly directed and taking an action with the interaction if the interaction was incorrectly directed.

### BACKGROUND

The present invention relates generally to the field of device applications and more particularly to asynchronous rendering of user interfaces.

Modern computing devices utilize program applications for a number of different functions and purposes, such as web browsers, calendars and email clients, for example. Every program application has a uniquely designed user interface by which a user may interact with the application and direct its functionality. Asynchronous rendering of a user interface refers to when different elements of a user interface are not rendered on an application page all at once but instead are rendered at different times in a certain order until the entire application page has loaded.

The application page is displayed on the device screen and can in general take up the whole device screen, a portion of the device screen or even extend beyond the boundaries of the device screen, wherein functions such as page scrolling enable a user to selectively view portions of the whole application page. Asynchronous rendering can involve UI elements being rendered in a certain position on the application page and then repositioned as the loading progresses.

### SUMMARY

According to one embodiment of the present invention, a method for preventing accidental interaction when rendering a user interface is provided, the method comprising monitoring a screen record comprising one or more screen positions and one or more draw times for one or more user interface components; responsive to an interaction with a first user interface component, recording an interaction time and retrieving a draw time, associated with the first user interface component, from the screen record; calculating a result indicating whether or not the interaction was directed to an incorrect user interface component; and responsive to the result indicating that the interaction was directed to an incorrect user interface component, taking an action associated with the interaction. A corresponding computer program product and computer system are also disclosed herein.

### BRIEF DESCRIPTION OF THE DRAWINGS

FIG. 1A-B is a functional block diagram illustrating a distributed data processing environment and a functional block diagram illustrating components of an interaction controller, respectively, in accordance with an embodiment of the present invention;

FIG. 2 is a flowchart depicting operational steps of an interaction controller, in accordance with an embodiment of the present invention; and

FIG. 3 is a block diagram of components of a computer system executing an interaction controller, in accordance with an embodiment of the present invention.

### DETAILED DESCRIPTION

Embodiments of the present invention recognize that many user interfaces presented in web pages or other types of program applications are rendered asynchronously, causing user interface (UI) components to shift out of position as the page or application is loading. This can lead to a user accidentally interacting with a different UI component than a target UI component which they had intended to interact with, which can cause disruptions. For example, instead of clicking a target UI component, a user might accidentally click on a pop-up advertisement in a web page which has popped up in place of the target UI component (which has since been shifted to a different position on the page), causing the browser to open a new web page. Embodiments of the present invention therefore present a solution which can determine a user's actual intent when interacting with a UI and can redirect interactions, such as, but not limited to, a mouse click, a key stroke, a touch, tap or gesture (i.e., on a touch screen device), to a target UI component.

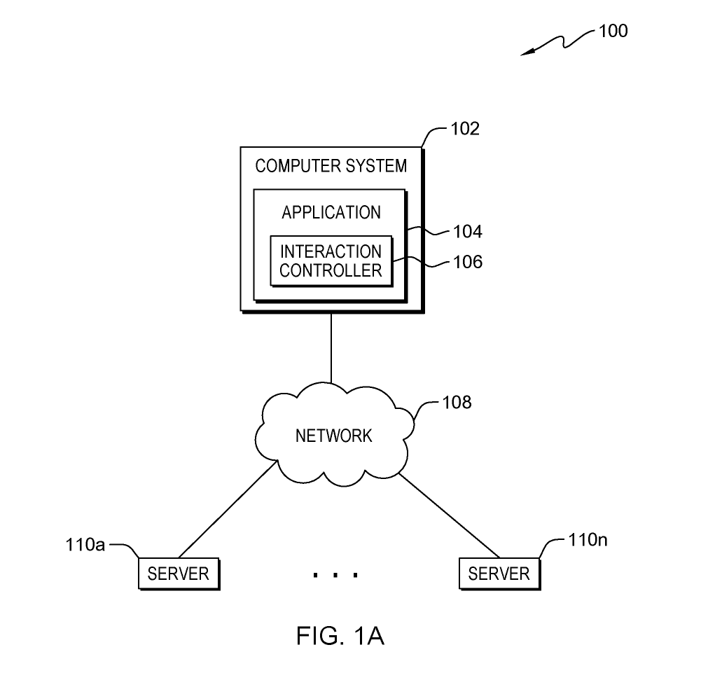

The present invention will now be described in detail with reference to the figures. FIG. 1A is a functional block diagram illustrating a distributed data processing environment 100, in accordance with one embodiment of the present invention. Distributed data processing environment 100 includes computer system 102 and servers 110a-n, interconnected over network 108.

Computer system 102 can be a laptop computer, tablet computer, netbook computer, personal computer (PC), a desktop computer, a personal digital assistant (PDA), a smart phone, or any programmable electronic device capable of communicating with servers 110a-n via network 108. Computer system 102 comprises application 104 which can be for example, but is not limited to, a web browser. Application 104 comprises interaction controller 106 which can determine a user's intent when interacting with a UI provided by application 104 and redirect interactions to target UI components. It should be noted that interaction controller 106 can alternatively be built into or downloaded and installed to computer system 102. Interaction controller 106 can provide functionality to any program applications (e.g., application 104) using operating system level controls.

Computer system 102 can send and/or receive data related to the content of application 104 from servers 110a-n, which can be any computer systems configured to serve requests made from client devices. In general, servers 110a-n represent any number of server computers configured to serve requests made over network 108.

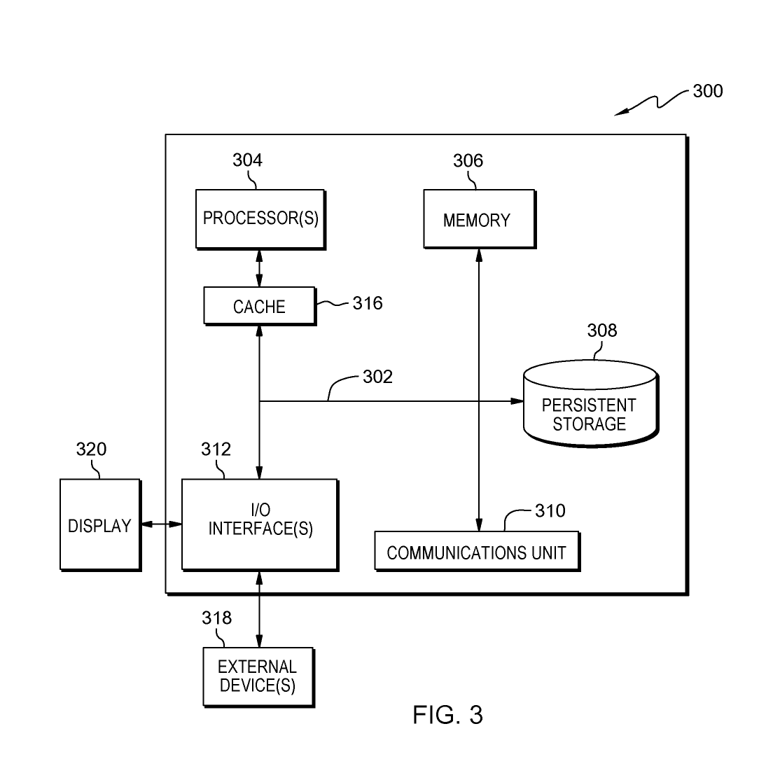

Network 108 can be, for example, a local area network (LAN), a wide area network (WAN) such as the Internet, or a combination of the two, and can include wired, wireless, or fiber optic connections. In general, network 108 can be any combination of connections and protocols that will support communications between computer system 102 and servers 110a-n. Computer system 102 can include internal and external hardware components, as depicted and described in further detail with respect to FIG. 3.

FIG. 1B is a functional block diagram depicting components of interaction controller 106. Interaction controller 106 comprises screen record monitor 112, interaction calculator 113 and interaction director 114. Screen record monitor 112 is a subsystem configured to monitor and retrieve data from a screen record of UI components, wherein the UI components can be rendered on the display screen of computer system 102. The screen record comprises at least the screen position of each UI component of application 104 and the draw time of each UI component (i.e., the time when the UI component was rendered on the screen). Data retrieved from the screen record, such as draw times and screen positions of UI components, can be sent to interaction calculator 113 which can perform a calculation to determine whether or not an interaction was intended for a different UI component (i.e., a target UI component) other than the UI component selected, as will be discussed subsequently.

Interaction director 114 is a subsystem of interaction controller 106 which can be configured to communicate with screen record monitor 112 and interaction calculator 113 to redirect interactions to target UI components if it has been determined that an interaction has been directed to an incorrect UI component. Interaction director 114 can receive data from screen record monitor 112 to determine the screen position of a target UI component and direct the interaction to it, instead of the incorrect UI component.

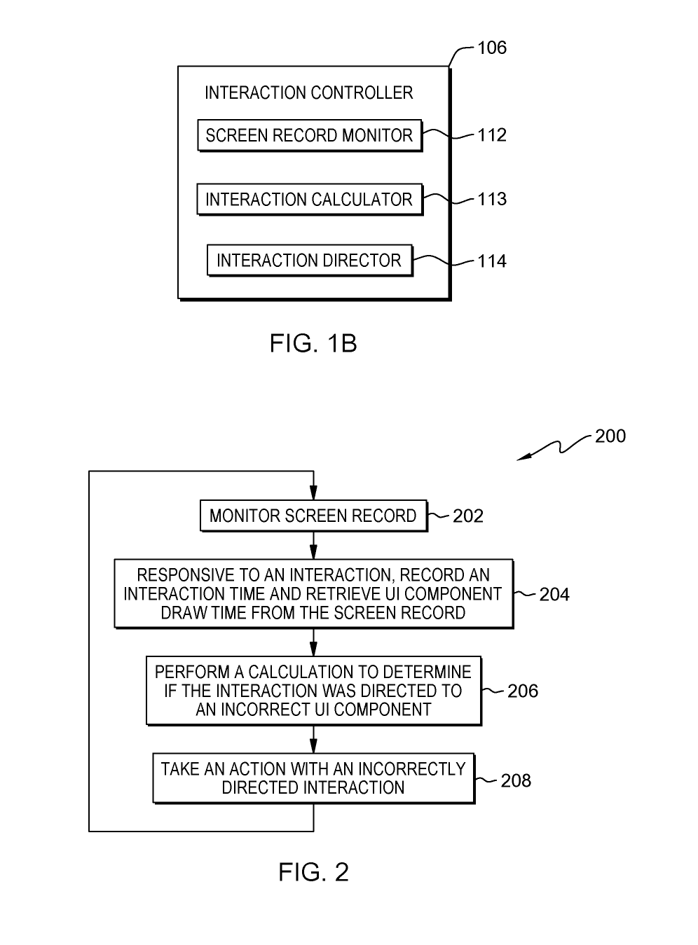

FIG. 2 is a flowchart 200 depicting operational steps of interaction controller 106, in accordance with an embodiment of the present invention. The screen record is monitored, at block 202, by screen record monitor 112, which is configured to retrieve data from the screen record. When a user interacts with a UI component of application 104, such as, for example, by clicking on it, the interaction time (i.e., the time when a user interacts with a UI component) is recorded by screen record monitor 112 and the draw time for the UI component that the user interacted with is retrieved, at block 204, from the screen record by screen record monitor 112. Both the interaction time and draw time are sent from screen record monitor 112 to interaction calculator 113.

At block 206, interaction calculator 113 performs a calculation to determine whether or not a user's interaction was directed to an incorrect UI component, i.e., the interaction was directed to a UI component other than the intended target UI component. The calculation can comprise, but is not necessarily limited to, subtracting the draw time (e.g., for the UI component interacted with) from the interaction time and comparing the difference to a predetermined threshold amount of time, which can be user configured. As an example, if the predetermined threshold is set to one second and a user were to click on a UI component less than one second after it was drawn on the screen (i.e., a difference less than the threshold), this can be an indication that the interaction was intended for a different UI component of application 104, i.e., the target UI component, which can have shifted out of place while application 104 was loading. If the calculation result indicates that the interaction was directed to an incorrect UI element, this result can be communicated to interaction director 114.

At block 208, embodiments can take an action with an interaction that was calculated to be directed to an incorrect UI element. For example, interaction director 114, responsive to receiving a result from interaction calculator 113 indicating an incorrectly directed interaction, can communicate with screen record monitor 112 to determine what target UI component was in the screen position of the incorrect UI component prior to the draw time of the incorrect UI component. The current screen position of the target UI component can then be retrieved from the screen record and sent to interaction director 114, which can redirect the interaction from the incorrect UI component to the target UI component.

Alternatively, it should be noted that according to other embodiments of the present invention, if interaction calculator 113 calculates that an interaction was directed to an incorrect UI component (such as in the manner previously described), interaction director 114 can, for example, cancel the interaction or prompt a user (e.g., such as through a pop-up notification) to confirm that the interaction was deliberate.

FIG. 3 depicts a block diagram 300 of components of computer system 102, in accordance with an illustrative embodiment of the present invention. It should be appreciated that FIG. 3 provides only an illustration of one implementation and does not imply any limitations with regard to the environments in which different embodiments can be implemented. Many modifications to the depicted environment can be made.

Computer system 102 includes communications fabric 302, which provides communications between cache 316, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a crossbar switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Application 104 and interaction controller 106 can be stored in persistent storage 308 and in memory 306 for execution by one or more of the respective computer processors 304 via cache 316. In an embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 can also be removable. For example, a removable hard drive can be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 can provide communications through the use of either or both physical and wireless communications links. Application 104 and/or interaction controller 106 can be downloaded to persistent storage 308 through communications unit 310.

I/O interface(s) 312 allows for input and output of data with other devices that can be connected to computer system 102. For example, I/O interface 312 can provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., interaction controller 106, can be stored on such portable computer readable storage media and can be loaded onto persistent storage 308 via I/O interface(s) 312. I/O interface(s) 312 also connect to a display 320.

Display 320 provides a mechanism to display data to a user and can be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for preventing accidental interaction when rendering a user interface, the method comprising:
monitoring a screen record comprising one or more screen positions and one or more draw times for one or more user interface components;
responsive to an interaction with a first user interface component, recording an interaction time and retrieving a draw time, associated with the first user interface component, from the screen record;
calculating a result indicating whether or not the interaction was directed to an incorrect user interface component; and
responsive to the result indicating that the interaction was directed to an incorrect user interface component, taking an action associated with the interaction.

2. The method of claim 1, wherein the interaction comprises at least one of a mouse click, a key stroke, a touch, a tap and a gesture.

3. The method of claim 1, wherein calculating the result is based on comparing a difference of the draw time subtracted from the interaction time to a predetermined threshold.

4. The method of claim 1, wherein the action comprises at least one of redirecting the interaction to a target user interface component, cancelling the interaction and prompting a user to confirm that the interaction was deliberate.

5. The method of claim 4, wherein the target user interface component is a second user interface component that was previously in the screen position of the first user interface component.

6. The method of claim 1, wherein the one or more user interface components are rendered asynchronously.

7. The method of claim 1, wherein the interaction time is a time associated with an interaction with the first user interface component.

8. A computer program product for preventing accidental interaction when rendering a user interface, the computer program product comprising:
one or more computer readable storage media and program instructions stored on the one or more computer readable storage media, the program instructions comprising:
program instructions to monitor a screen record comprising one or more screen positions and one or more draw times for one or more user interface components;
program instructions to, responsive to an interaction with a first user interface component, record an interaction time and retrieve a draw time, associated with the first user interface component, from the screen record;
program instructions to calculate a result indicating whether or not the interaction was directed to an incorrect user interface component; and
program instructions to, responsive to the result indicating that the interaction was directed to an incorrect user interface component, take an action associated with the interaction.

9. The computer program product of claim 8, wherein the interaction comprises at least one of a mouse click, a key stroke, a touch, a tap and a gesture.

10. The computer program product of claim 8, wherein calculating the result is based on comparing a difference of the draw time subtracted from the interaction time to a predetermined threshold.

11. The computer program product of claim 8, wherein the action comprises at least one of redirecting the interaction to a target user interface component, cancelling the interaction and prompting a user to confirm that the interaction was deliberate.

12. The computer program product of claim 11, wherein the target user interface component is a second user interface component that was previously in the screen position of the first user interface component.

13. The computer program product of claim 8, wherein the one or more user interface components are rendered asynchronously.

14. The computer program product of claim 8, wherein the interaction time is a time associated with an interaction with the first user interface component.

15. A computer system for preventing accidental interaction when rendering a user interface, the computer system comprising:
one or more computer processors;
one or more computer readable storage media;
program instructions stored on the one or more computer readable storage media for execution by at least one of the one or more processors, the program instructions comprising:
program instructions to monitor a screen record comprising one or more screen positions and one or more draw times for one or more user interface components;
program instructions to, responsive to an interaction with a first user interface component, record an interaction time and retrieve a draw time, associated with the first user interface component, from the screen record;
program instructions to calculate a result indicating whether or not the interaction was directed to an incorrect user interface component; and
program instructions to, responsive to the result indicating that the interaction was directed to an incorrect user interface component, take an action associated with the interaction.

16. The computer system of claim 15, wherein the interaction comprises at least one of a mouse click, a key stroke, a touch, a tap and a gesture.

17. The computer system of claim 15, wherein calculating the result is based on comparing a difference of the draw time subtracted from the interaction time to a predetermined threshold.

18. The computer system of claim 15, wherein the action comprises at least one of redirecting the interaction to a target user interface component, cancelling the interaction and prompting a user to confirm that the interaction was deliberate.

19. The computer system of claim 18, wherein the target user interface component is a second user interface component that was previously in the screen position of the first user interface component.

20. The computer system of claim 15, wherein the interaction time is a time associated with an interaction with the first user interface component.
